(19) United States
(12) Patent Application Publication
(10) Pub. No.: US 2025/0038387 A1
(43) Pub. Date: Jan. 30, 2025

(54) Transmission line in a superconducting circuit

(71) Applicant: IQM FINLAND OY, Espoo (FI)

(72) Inventor: Jukka RÄBINÄ, Espoo (FI)

(21) Appl. No.: 18/716,030

(22) PCT Filed: Dec. 15, 2021
(86) PCT No.: PCT/FI2021/050877

§ 371 Date: Jun. 3, 2024

(51) Int. Cl. H01P 3/00; H01P 7/08

(52) U.S. Cl. CPC H01P 3/006; H01P 7/086

(57) ABSTRACT

This disclosure describes devices which comprise a superconducting circuit and a circuit connector which couples the superconducting circuit to external circuitry. The superconducting circuit comprises a circuit resonator and a transmission line coupled between the circuit connector and the circuit resonator. The length of transmission line is such that the current which passes between the circuit connector and the transmission line is substantially zero when a drive signal is applied to the circuit resonator through the transmission line.

### FIELD OF THE DISCLOSURE

The present disclosure relates to superconducting circuits, and particularly to superconducting circuits containing resonating circuit elements. The present disclosure further concerns transmission lines which connect resonating circuit elements to external circuitry.

### BACKGROUND OF THE DISCLOSURE

Elements which exhibit electrical resonance are commonly used in superconducting circuits, for example to realize qubits in quantum computers. Such circuit resonators may for example be traditional quarter-wave or half-wave transmission line resonators, or they can consist of capacitive and inductive components coupled with Josephson junctions.

A circuit resonator typically has a known target frequency which can be determined when the circuit is designed. When a superconducting circuit containing the circuit resonator is operated, a drive signal generated in an external circuit can be transmitted to the resonator through a transmission line in the superconducting circuit. If the drive signal frequency matches the known resonance frequency of the circuit resonator, the signal sets the resonator into an operational state.

Circuit resonators which belong to the same superconducting circuit should preferably operate independently of one another in most applications. It is for this reason often necessary to dedicate a separate transmission line to each circuit resonator. Its operation will then ideally not be influenced by the drive signals that are sent to other resonators in the same superconducting circuit.

Superconducting circuits with transmission lines dedicated to individual qubits are known from the prior art. A common problem in such circuits is that there is significant crosstalk between transmission lines due to the strong electric fields that the drive signal generates in each line.

### BRIEF DESCRIPTION OF THE DISCLOSURE

An object of the present disclosure is to provide an apparatus which alleviates the crosstalk problem in superconducting circuits a simple way. The object of the disclosure is achieved by an arrangement which is characterized by what is stated in the independent claim. The preferred embodiments of the disclosure are disclosed in the dependent claims.

The disclosure is based on the idea of selecting the length of a transmission line in such a manner that the electric field which surrounds the line decreases rapidly as a function of distance from the transmission line. An advantage of the arrangement of this disclosure is that the drive signal can be effectively fed to the desired resonator without influencing other resonators in the same superconducting circuit.

### BRIEF DESCRIPTION OF THE DRAWINGS

In the following the disclosure will be described in greater detail by means of preferred embodiments with reference to the accompanying drawings, in which

FIG. 1a illustrates a device with a superconducting circuit.

FIG. 1b illustrates a cross-section of a co-planar waveguide.

FIG. 1c illustrates a capacitively coupled open-circuited transmission line.

FIG. 1d illustrates an inductively coupled short-circuited transmission line.

FIG. 2 illustrates a circuit substrate, a holding structure and a superconducting circuit.

### DETAILED DESCRIPTION OF THE DISCLOSURE

This disclosure describes devices that comprise a superconducting circuit and a circuit connector which couples the superconducting circuit to external circuitry. The superconducting circuit comprises a circuit resonator which has a target resonance frequency. The superconducting circuit also comprises a transmission line with a first end and a second end. The first end of the transmission line is coupled to the circuit resonator and the second end of the transmission line is coupled to the circuit connector. In other words, the superconducting circuit comprises a circuit resonator, a circuit connector, and a transmission line coupled between the circuit resonator and the circuit connector.

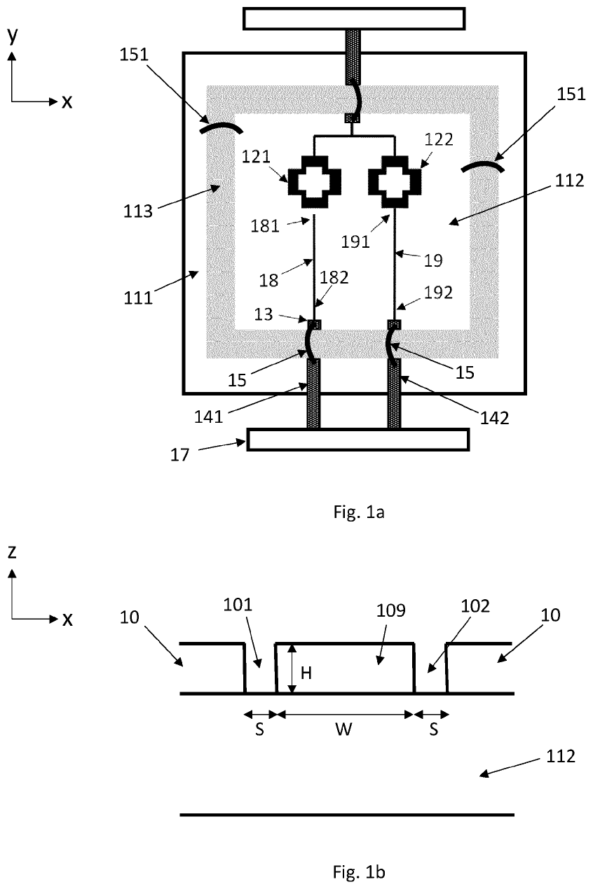

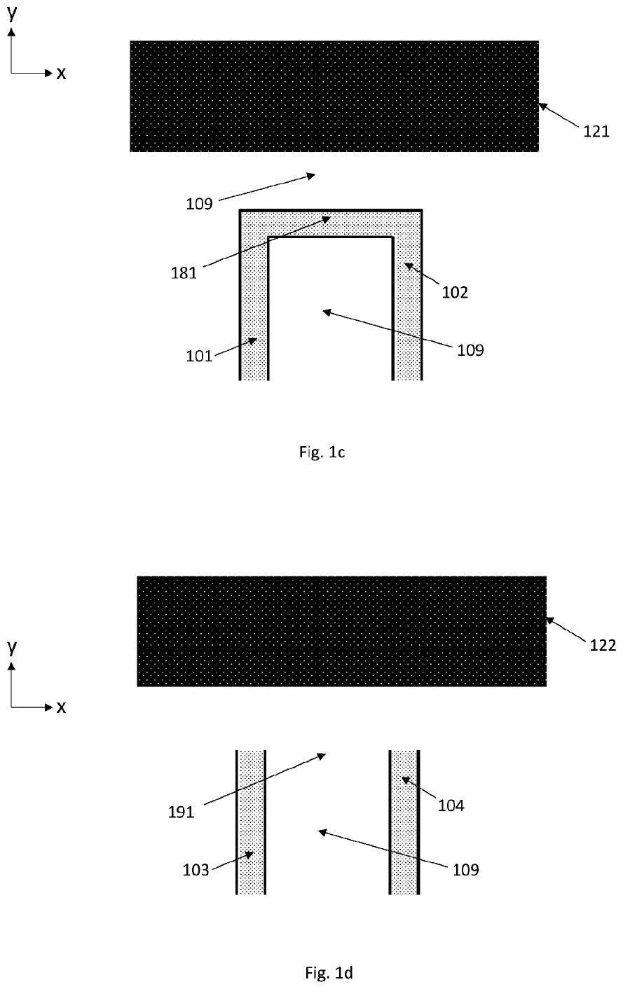

FIG. 1a illustrates schematically a device with a superconducting circuit. The device is illustrated in an xy-plane which may be called the device plane or the horizontal plane. A z-direction, which may be called the vertical direction, is perpendicular to the xy-plane. The words “horizontal” and “vertical” here only refer to a plane and to a direction which is perpendicular to that plane. They do not imply anything about how the device should be oriented when it is used or when it is manufactured.

The device in FIG. 1a comprises first and second circuit resonators 121-122. The circuit resonators described in this disclosure may for example be qubits. Alternatively, they can be any other kind of high-frequency circuit resonator which can be implemented in a superconducting circuit.

The superconducting circuit is built on a circuit substrate 112, which may for example be a silicon substrate. The circuit substrate 112 may for example be attached to holding structure 111 which provides structural support and comprises electrical connections to external circuitry. The arrangement illustrated in FIG. 1a is only one possibility. Many other arrangements and geometries are also possible for connecting external circuitry to the superconducting circuit. A gap 113 may separate the circuit substrate 112 from the holding structure 111.

The circuit substrate 112 may be coated with a superconducting layer (not separately illustrated in FIG. 1a). The superconducting circuit is formed in the superconducting layer. The superconducting layer may for example be a layer of Nb, Al, TiN, NbN, NbTiN or Ta. The device comprises circuit connectors 141-142 which couple the superconducting circuit to external circuitry 17. These circuit connectors may for example be arranged at least partly on the holding structure 111 which is adjacent to the circuit substrate 112, as FIG. 1a illustrates. Alternatively, they could be arranged on some other device part which is adjacent to the circuit substrate 112.

The superconducting circuit in FIG. 1a comprises a first transmission line 18 with a first end 181 and a second end 182. The first end 181 of the first transmission line 18 is capacitively coupled to the first circuit resonator 121 and the second end 182 of the first transmission line is coupled with an electrical connector to the first circuit connector 141. Here capacitive coupling means that the transmission line is separated electrically from the resonator by a separator, so there is no direct electrical contact, but the first end of the transmission line is close enough to the resonator to interact with the resonator electrically across the separator.

The electrical connectors presented in this disclosure may for example include wire bonds 15, or any other electrical connection which couples the second end of a transmission line directly to the circuit connector. The superconducting circuit may for example also comprise an electrode region 13 where each transmission line terminates, and the electrode region 13 and wire bond 15 may then together form the electrical connector which connects the transmission line directly to the circuit connector. The device may comprise additional wires 151 which may be used to set some areas of the superconducting layer on the surface of the circuit substrate to ground potential by connecting them to ground regions on the holding structure 111.

The superconducting circuit in FIG. 1a also comprises a second transmission line 19 with a first end 191 and a second end 192. The first end 191 of the second transmission line 19 is inductively coupled to the second circuit resonator 122 and the second end 192 of the second transmission line 19 is coupled with an electrical connector to the second circuit connector 142.

FIG. 1b illustrates an xz-cross section of a co-planar waveguide which can be used as a transmission line. The superconducting layer 10 covers the circuit substrate 112. The transmission line 18 can be a co-planar waveguide which is created in the superconducting layer by etching a first waveguide trench 101 and a second waveguide trench 102 in the superconducting layer. The waveguide trenches 101 and 102 thereby form a center conductor 109 in the transmission line. The transmission line may have a characteristic center conductor width W in a horizontal direction, determined by the distance between the waveguide trenches 101 and 102. The gap width S also influences the properties of the transmission line. The center conductor width W may for example be in the range 0.1-500 μm, or in the range 2-50 μm. The gap width S may for example be in the range 0.1-500 μm, or in the range 2-50 μm. W and S do not necessarily have to be constant along the full length of the transmission line. In an exemplary embodiment, W and S may both be in the range 2-50 μm in the narrowest parts of the transmission line. The height H of the superconducting layer 10 determines the depth of the waveguide trenches 101 and 102. The variable which is most important in this disclosure is the length of the transmission line—the distance from its first end to its second end—which will be discussed in more detail below.

A transmission line in a superconducting circuit may be coupled to a circuit resonator either capacitively or inductively. In FIG. 1a, the first transmission line 18 is an open-circuited transmission line which is coupled capacitively to the first circuit resonator 121. FIG. 1c illustrates this capacitive coupling in more detail. It shows the first end 181 of the first transmission line 18 adjacent to the first circuit resonator 121 (which is only partly illustrated). An open-circuited transmission line is created by joining the first waveguide trench 101 to the second waveguide trench 102. Consequently, the center conductor 109 which lies between the first and second waveguide trenches 101 and 102 is separated from the other parts of the superconducting layer by these trenches. When a drive signal is delivered to the transmission line, the AC current at the first end 181 of the first transmission line 18 will be zero. Nevertheless, a high-frequency electromagnetic wave in the first transmission line 18 generates an oscillating current in the first circuit resonator 121 through capacitive interaction. The first circuit resonator 121 can thereby be driven into resonance by a drive signal which oscillates in the transmission line 18. An open-circuited transmission line may also be called an open-ended transmission line.

In FIG. 1a, the second transmission line 19 is a short-circuited transmission line which is coupled inductively to the second circuit resonator 122. FIG. 1d illustrates inductive coupling in more detail. The second transmission line 19 is formed by third and fourth waveguide trenches 103 and 104. The third and fourth waveguide trenches terminate before they reach the second circuit resonator 122 (which is only partly illustrated). The center conductor 109 which lies between the third and fourth waveguide trenches 103 and 104 is directly connected to the surrounding areas of the superconducting layer, which are set to ground potential. When a drive signal is brought to the transmission line, the AC current at the first end 191 of the transmission line will obtain a maximal value due to this short-circuiting connection. The current which flows through the first end 191 of the second transmission line 19 induces an alternating current in the second circuit resonator 122. Consequently, the second circuit resonator 122 can be driven into resonance by a drive signal which oscillates in the short-circuited transmission line 19. A short-circuited transmission line may also be called a short-ended transmission line.

The electrical field which emanates from a transmission line depends on the properties of the transmission line and on the properties of the electrical connectors and circuit connectors through which the drive signal enters the transmission line. The electrical connectors typically have to be implemented with elements which have a significantly higher characteristic impedance than the transmission line itself. Wire bonds are one example of such an element. The higher the AC current which is driven back and forth across the electrical connector when the drive signal enters the transmission line, the stronger the electric field which radiates around the transmission line. Consequently, if the current through the electrical connector is minimized, the electric field will decrease rapidly as a function of distance from the transmission line. Consequently, crosstalk between adjacent transmission lines is minimized when the current is minimized.

When a high frequency drive signal is applied to a transmission line, the current through the electrical connector is at a minimum if the signal forms a substantially stationary wave in the transmission line so that the zero-current node of the stationary wave coincides with the second end of the transmission line where the electrical connector has been connected. Two different solutions can be developed from the analysis of open-circuited and short-circuited transmission lines above.

This disclosure describes devices which comprise a superconducting circuit and a circuit connector which couples the superconducting circuit to external circuitry. The superconducting circuit comprises a circuit resonator. The superconducting circuit also comprises a transmission line with a first end and a second end. The first end of the transmission line is coupled to the circuit resonator and the second end of the transmission line is coupled to the circuit connector. The length of transmission line is such that the current which passes between the circuit connector and the transmission line is substantially zero when a drive signal is applied to the circuit resonator through the transmission line.

### Open-Circuited Transmission Line Embodiment

In a first example embodiment, a device comprises a superconducting circuit and a circuit connector which couples the superconducting circuit to external circuitry. The superconducting circuit comprises a circuit resonator which has a target resonance frequency. The superconducting circuit also comprises a transmission line with a first end and a second end. The first end of the transmission line is coupled to the circuit resonator and the second end of the transmission line is coupled to the circuit connector. The transmission line has a characteristic effective speed of light. The transmission line is an open-circuited transmission line and the first end of the transmission line is capacitively coupled to the circuit resonator, and the length of the transmission line is substantially equal to (N*L)/2, where N is a positive integer and L equals the effective speed of light divided by the target resonance frequency.

The effective speed of light depends on the material and the geometry of the transmission line. The effective speed of light of a given transmission line can easily be calculated, and it can to some extent also be adjusted by changing the geometry.

The AC-current at the first end 181 of the open-circuited first transmission line 18 discussed above is zero because the transmission line terminates at this point. A stationary wave in this first transmission line exhibits its next zero-current point at a distance D₁=L/2 from the first end 181. If the wavelength is long enough, successive zero-current points will occur at distances D₂=L, D₃=3 L/2, or more generally (N*L)/2, where N is a positive integer. N may for example be one, two, three, four or any other positive integer.

In other words, the current at the second end 182 of the transmission line can be minimized by making the length of the transmission line equal to a multiple of L/2. Since the frequency of the drive signal equals the target resonance frequency, the wavelength L is calculated by dividing the effective speed of light with the target resonance frequency.

The transmission line may be a co-planar waveguide. Regardless of whether or not the transmission line is a co-planar waveguide, the transmission line may have a meandering shape.

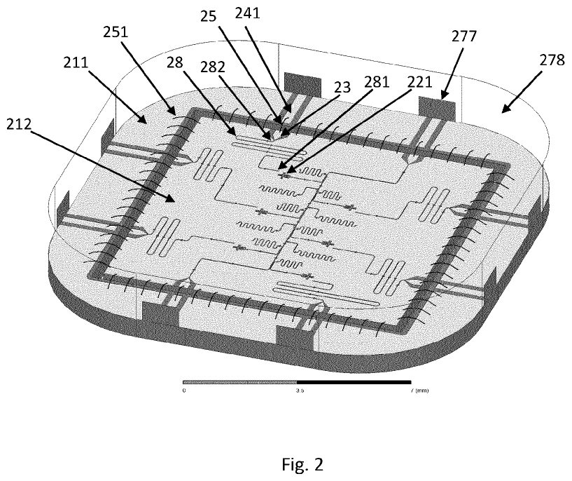

The first transmission line does not need to have the shape of a straight line. FIG. 2 illustrates a superconducting circuit where reference numbers 211, 212, 221 23, 241, 25, 251, 28, 281 and 282 correspond to reference numbers 111, 112, 121, 13, 141, 15, 151, 18, 181 and 182, respectively, in FIG. 1a. The illustrated circuit comprises six circuit resonators, and each of these resonators is coupled to the external circuit through a transmission line such as 18. The transmission lines here have a meandering shape which allows each transmission line to be confined to a relatively small area while still being sufficiently long to achieve a length of (N*L)/2. The length of the transmission line is measured from its first end to its second end along the transmission line path—in this case along the serpentine meander as it turns back and forth.

In FIG. 2 the square-shaped circuit substrate 212 has been placed within a square-shaped cavity in the holding structure 211. Each circuit connector 241 on the holding structure 211 is coupled to the corresponding transmission line 28 with a wire bond 15. Additional wires 251, placed in regions of the holding structure where no circuit connector is present, connect the top surface of the circuit substrate 212 electrically ground regions on the holding structure 211. The superconducting layer on the circuit substrate 212 can thereby be grounded. Other electrical connections could alternatively be used for setting the layer of superconducting material to ground potential.

The device illustrated in FIG. 2 may also comprises sidewalls 278 and a top cover (not illustrated). The sidewalls and the top cover may delimit a vacuum enclosure. The sidewalls and the top cover can for example be made of copper. The sidewalls 278 may comprise sealed through-holes 277 where circuit connectors 241 are coupled to external circuitry. The device architecture illustrated in FIG. 2 can also be used in the short-circuited transmission line embodiment presented below-only the detailed features of the transmission lines are different.

### Short-Circuited Transmission Line Embodiment

In second example embodiment, a device comprises a superconducting circuit and a circuit connector which couples the superconducting circuit to external circuitry. The superconducting circuit comprises a circuit resonator which has a target resonance frequency. The superconducting circuit also comprises a transmission line with a first end and a second end. The first end of the transmission line is coupled to the circuit resonator and the second end of the transmission line is coupled to the circuit connector. The transmission line has a characteristic effective speed of light. The transmission line is a short-circuited transmission line and the first end of the transmission line is inductively coupled to the circuit resonator. The length of the transmission line is substantially equal to (N*L)/2−(L/4), where N is a positive integer and L equals the effective speed of light divided by the target resonance frequency.

The analysis provided above in the first example embodiment can be applied to this second example embodiment with a few modifications. The AC-current at the first end 191 of the short-circuited second transmission line 19 discussed above reaches a maximum value IMAX because the first end is connected to the ground potential. A stationary wave in this first transmission line will exhibits its next zero-current point at a distance D₁=L/4=L/2−L/4 from the first end 191. If the wavelength is long enough, successive zero-current points will occur at distances D₂=L−L/4, D₃=3 L/2−L/4, or more generally (N*L)/2−(L/4), where N is a positive integer. N may for example be one, two, three, four or any other positive integer.

In other words, the current at the second end 192 of the transmission line can be minimized by making the length of the transmission line equal to (N*L)/2−(L/4). Since the frequency of the drive signal equals the target resonance frequency, the wavelength L is calculated by dividing the effective speed of light with the target resonance frequency.

As in the first example, the first transmission line does not need to have the shape of a straight line. The transmission line may have a meandering shape as FIG. 2 illustrates, which allows each transmission line to be confined to a relatively small area while still being sufficiently long to achieve a length of (N*L)/2−(L/4). The transmission line may be a co-planar waveguide, and regardless of whether or not the transmission line is a co-planar waveguide, the transmission line may have a meandering shape.

1. A device comprising a superconducting circuit and a circuit connector which couples the superconducting circuit to external circuitry, wherein the superconducting circuit comprises
a circuit resonator which has a target resonance frequency,
a transmission line with a first end and a second end, wherein the first end is coupled to the circuit resonator and the second end is coupled to the circuit connector,
wherein the transmission line has a characteristic effective speed of light,
wherein the transmission line is an open-circuited transmission line and the first end of the transmission line is capacitively coupled to the circuit resonator, and the length of the transmission line is substantially equal to (N*L)/2, where N is a positive integer and L equals the effective speed of light divided by the target resonance frequency.

2. The device according to claim 1, wherein the transmission line is a co-planar waveguide.

3. The device according to claim 1, wherein the transmission line has a meandering shape.

4. A device comprising a superconducting circuit and a circuit connector which couples the superconducting circuit to external circuitry, wherein the superconducting circuit comprises
a circuit resonator which has a target resonance frequency,
a transmission line with a first end and a second end, wherein the first end is coupled to the circuit resonator and the second end is coupled to the circuit connector,
wherein the transmission line has a characteristic effective speed of light,
wherein the transmission line is a short-circuited transmission line and the first end of the transmission line is inductively coupled to the circuit resonator, and the length of the transmission line is substantially equal to (N*L)/2−(L/4), where N is a positive integer and L equals the effective speed of light divided by the target resonance frequency.

5. The device according to claim 4, wherein the transmission line is a co-planar waveguide.

6. The device according to claim 4, wherein the transmission line has a meandering shape.
